(19) United States
(12) Patent Application Publication
(10) Pub. No.: US 2014/0149531 A1
(43) Pub. Date: May 29, 2014

(54) SYSTEM AND METHOD OF PROVIDING CONTENTS WITH TIC SERVER AND CDN

(71) Applicant: Electronics and Telecommunications Research Institute, Daejeon (KR)

(72) Inventors: Hyung Seok CHUNG, Daejeon (KR); Ho Young SONG, Daejeon (KR); Seung Hyun YOON, Daejeon (KR); Byong Kwon MOON, Daejeon (KR); Hong Seok JEON, Daejeon (KR); Tae Yeon KIM, Daejeon (KR); Byeong Sik KIM, Daejeon (KR)

(73) Assignee: Electronics and Telecommunications Research Institute, Daejeon (KR)

(21) Appl. No.: 14/089,641

(22) Filed: Nov. 25, 2013

(30) Foreign Application Priority Data
Nov. 26, 2012 (KR) 10-2012-0134438

(51) Int. Cl. H04L 29/08

(52) U.S. Cl. CPC H04L 67/2842
USPC 709/213

(57) ABSTRACT

The present invention relates to a content providing system and method combining a transparent Internet cache (TIC) server and a content delivery network (CDN), and more particularly, to a content providing system and method that may overcome limitation on capacity of a cache storage found in a TIC service and may also overcome limitation on service transparency found in a CDN service. According to the present invention, it is possible to overcome limitation on capacity of a cache storage found in an existing TIC service and to overcome limitation on service transparency found in a CDN by combining a TIC server and the CDN.

### CROSS-REFERENCE TO RELATED APPLICATIONS

This application claims priority to and the benefit of Korean Patent Application No. 10-2012-0134438 filed in the Korean Intellectual Property Office on Nov. 26, 2012, the entire contents of which are incorporated herein by reference.

### TECHNICAL FIELD

The present invention relates to a content providing system and method combining a transparent Internet cache (TIC) server and a content delivery network (CDN), and more particularly, to a content providing system and method that may overcome limitation on capacity of a cache storage found in a TIC service and may also overcome limitation on service transparency found in a CDN service.

### BACKGROUND ART

Currently, with the distribution of an Internet video service called over the top (OTT), OTT traffic is inundating Internet protocol (IP) network roads (an international line, a backbone, a backhaul, and an access) of Internet Service Provider (ISP). Such OTT traffic does not pay a service fee for using a road of the Internet Service Provider and thus, the Internet Service Provider is spending tremendous amounts of expenditures for increasing networks but not using any type of profitability model.

A plurality of technologies for decreasing OTT traffic is proposed and one of the technologies is a transparent Internet cache (TIC). The TIC refers to a technology of decreasing costs of an International line and a backbone network by caching OTT content in an Internet service provider (ISP) network and providing cached content from a cache server within the ISP network when a user requests content.

A content delivery network (CDN) technology is proposed to decrease the OTT traffic. In the case of a service for providing large capacity content, such as high quality video or streaming, the service is being smoothly provided to a user over a CDN operated by a CDN service provider.

The CDN refers to a technology designed to prevent a degradation in a transmission rate of large capacity content and to solve an instability issue, and also refers to a technology of installing a plurality of cache servers at a bottom of an ISP network, moving content provided by a contents provider (CP) to a cache server in advance, and delivering the content stored in the cache server to a user when the user requests the content. That is, the CDN improves a transmission rate by moving the content requested by the user in advance to be close to the user. The CDN may improve Internet access quality and content transmission rate issues by decreasing an amount of load that is generated when content passes through a plurality of ISP networks, optimizing a movement path, and preventing traffic from being concentrating at a single point.

However, similar to an OTT provider such as a CP, a CDN provider is also making a great deal of profits by using a network prepared by an Internet Service Provider nearly free of charge.

Accordingly, to decrease traffic load of an OTT service and to provide a fast communication service, Internet Service Providers are making competitive efforts to reorganize a current CP centric profitability structure by proceeding with introduction of a TIC server and also carrying forward introduction of a CDN.

In the case of a general TIC, relatively small capacity data such as a short video clip may not become a big issue in terms of a storage space of a cache server. However, large capacity data such as a high quality video may cause an issue in terms of the storage space of the cache server.

Meanwhile, a CDN service has advantages in that it is possible to quickly service even large capacity content, such as a high quality video, to a user through a distributive storage and delivery service of large capacity data and at the same time, is possible to decrease traffic load of a backbone network of an Internet Service Provider. However, the CDN service has a disadvantage in protecting paid content provided by a CP, which is different from a TIC service.

### SUMMARY OF THE INVENTION

The present invention has been made in an effort to provide a content providing system and a content providing method that may overcome limitation on capacity of a cache storage found in a transparent Internet cache (TIC) service and may also overcome limitation on service transparency found in a content delivery network (CDN) service.

An exemplary embodiment of the present invention provides a content providing method performed by a content providing system including a CDN and a TIC server configured to cache content and deliver the cached content to a user terminal, the method including: redirecting, by a router, a content request signal received from the user terminal to the TIC server; requesting, by the TIC server, an origin server for content corresponding to the content request signal; receiving, by the TIC server, a portion of corresponding content from the origin server, and determining whether the corresponding content is large capacity content; caching, by the TIC server, the corresponding content, and providing the cached corresponding content to the user terminal when the corresponding content is determined as small capacity content; and caching, by the CDN, the corresponding content, and providing the cached corresponding content to the user terminal when the corresponding content is determined as the large capacity content.

Another exemplary embodiment of the present invention also provides a content providing system including a CDN and a TIC server configured to cache content and deliver the cached content to a user terminal, the system including: a router configured to intercept a content request signal and to redirect the content request signal to the TIC server; an origin server configured to store originals of various contents; the TIC server configured to cache small capacity content from the origin server and to provide the cached small capacity content to the user terminal; and the CDN configured to cache large capacity content from the origin server and to provide the cached large capacity content to the user terminal. The TIC server requests the origin server for content corresponding to the content request signal, receives a portion of corresponding content from the origin server, determines a characteristic of corresponding content, and determines a providing entity of corresponding content based on whether the corresponding content is large capacity content.

According to exemplary embodiments of the present invention, it is possible to overcome limitation on capacity of a cache storage found in an existing TIC service and to overcome limitation on service transparency found in a CDN service by combining a TIC server and a CDN.

According to exemplary embodiments of the present invention, it is possible to provide a fast service to a user and not to affect a business model of service providers by combining an Internet Service Provider centric CDN and an existing TIC server and delivering content to both a user and a service provider in a transparent manner, and to improve a profitability structure by providing a fast service to a Internet Service Provider and decreasing traffic load.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a content providing system according to the present invention.

FIG. 2 is a flowchart illustrating a content providing method according to the present invention.

FIG. 3 is a flowchart to describe in detail operations S10 to S40 of FIG. 2.

FIG. 4 is a flowchart illustrating an operation process in a case in which corresponding content is not stored in a local cache within a transparent Internet cache (TIC) server.

FIG. 5 is a flowchart illustrating an operation process in a case in which corresponding content is stored in a local cache within a TIC server.

FIG. 6 is a flowchart illustrating a process of delivering, by a CDN, corresponding content to a user terminal.

FIG. 7 is a flowchart to describe in detail a process of delivering, by a CDN, corresponding content to a user terminal.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Various modifications and changes may be made to the present invention and certain exemplary embodiments are illustrated in drawings and are described in detail in the specification. However, the certain exemplary embodiments are not to limit the present invention to a predetermined disclosed mode and should be understood to include all of the modifications, equivalents, and alternatives included in the spirit and the technical scope of the present invention.

Terms such as a first and a second may be used to describe various constituent elements, but the constituent elements should not be limited by the terms. The terms are used only to distinguish one constituent element from another constituent element. For example, without departing from the scope of the present invention, a first constituent element may be referred to as a second constituent element and similarly, the second constituent element may also be referred to as the first constituent element.

Terms used in the present specification are simply used to describe certain exemplary embodiments and are not to limit the present invention. Unless clearly differently described in terms of context, a singular expression includes a plural expression. Terms such as “includes (comprises)” and “has” used in the present specification are used to designate presence of a feature, a number, a step, an operation a constituent element, a part, disclosed in the present specification, or combination thereof, and thus, should be understood not to pre-exclude the presence or addition of at least one another feature, number, step, operation, constituent element, part, or combination thereof.

Unless differently defined, all of the terms used herein, including a technical term or a scientific term, have the same meaning as a meaning generally understood by those skilled in the art.

Terms defined in a generally used dictionary should be understood to have a meaning that matches a contextual meaning of the art and should not be interpreted as an idealistic or excessively formal meaning unless clearly defined in the present specification.

Hereinafter, exemplary embodiments of the present invention will be described in detail with reference to the accompanying drawings. Like reference numerals disclosed in each drawing refer to like constituent elements.

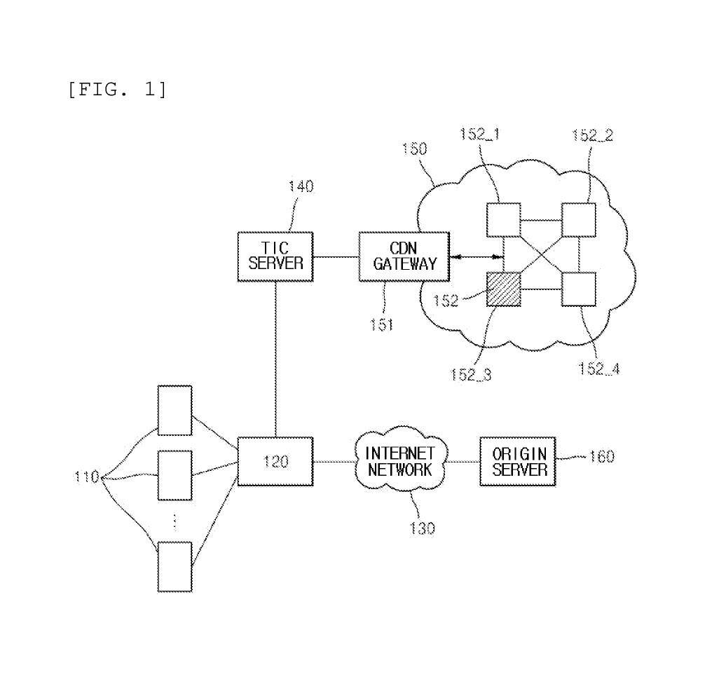

FIG. 1 is a diagram illustrating a content providing system 100 according to the present invention.

The content providing system 100 according to the present invention refers to a system for providing a service in which a transparent Internet cache (TIC) service and a content delivery network (CDN) service are combined and also refers to a system for providing large capacity content to a user through a CDN and providing small capacity content to the user through a TIC server.

The content providing system 100 according to the present invention includes a user terminal 110, a router 120, an Internet network 130, a TIC server 140, a CDN 150, and an origin server 160.

The user terminal 110 refers to a terminal configured to request the origin server 160 for content, receive the content, and output the received content, and includes not only a generally used computer terminal but also a smart phone and a table computer that are accessible to the Internet over the wireless Internet and a mobile communication network. The user terminal 110 generates a content request signal for requesting transmission of content desired by a user, and transmits the generated content request signal to the router 120.

The router 120 refers to a network apparatus configured to connect the user terminal 110 to a destination by referring to an address of the content request signal transmitted from the user terminal 110. An L4/L7 router may be used for the router 120. The L4/L7 router functions to analyze network traffic in the user terminal 110, to intercept a content request signal, and to deliver the intercepted content request signal to the TIC server 140, which will be described later. To this end, the router 120 functions to redirect, to the TIC server 140, an Internet protocol (IP) packet in a predetermined form, for example, hypertext transfer protocol (HTTP) GET.

The TIC server 140 functions to deliver content corresponding to the content request signal to the user terminal 110 instead of the origin server 160.

When the corresponding content is present within a local cache of the TIC server 140, the TIC server 140 transmits the corresponding content cached in the local cache to the user terminal 110. Conversely, when the corresponding content is absent in the local cache of the TIC server 140, the TIC server 140 requests the origin server 160 for the corresponding content, receives the corresponding content from the origin server 160, caches the received corresponding content to the local cache and at the same time, delivers the received corresponding content to the user terminal 110.

An operation of the TIC server 140 will be described more in detail.

Initially, the TIC server 140 receives the content request signal from the router 120, transmits the content request signal to the origin server 160 that stores the content corresponding to the content request signal, and requests the origin server 160 for the corresponding content.

Next, the TIC server 140 downloads a portion of corresponding content from the origin server 160.

The TIC server 140 verifies a characteristic of corresponding content based on the received content, and determines whether the corresponding content is large capacity content and whether the content is modified. Here, the large capacity content indicates that the corresponding content is at least one of content serviced using a streaming scheme and content compressed in an image format of a high quality video. The TIC server 140 may analyze a universal resource locator (URL) address of the origin server 160 storing the corresponding content or metadata of the downloaded portion of corresponding content, and may determine whether the corresponding content is large capacity content.

When the corresponding content is not large capacity content, the TIC server 140 transmits the corresponding content instead of the origin server 160. Here, in a case in which the corresponding content is cached to the local cache of the TIC server 140, the TIC server 140 transmits the corresponding content stored in the local cache to the user terminal 110. When the corresponding content is absent in the local cache of the TIC server 140 or when the corresponding content is modified, the TIC server 140 receives the corresponding content from the origin server 160, caches the received corresponding content to the local cache, and at the same time, delivers the corresponding content to the user terminal 110.

Meanwhile, when the corresponding content is one of content serviced using a streaming scheme and high quality video content, the TIC server 140 delivers the content request signal of the user to the CDN 150 so that the CDN 150 transmits the corresponding content to the user terminal 110 instead of the origin server 160. The CDN 150 will be described later.

The CDN 150 includes a CDN gateway 151 and CDN nodes 152_1, 152_2, 152_3, and 152_4.

The CDN gateway 151 selects, as an optimal node, a CDN node 152 closest to the user terminal 110 or having the highest availability among the plurality of CDN nodes 152_1 to 152_4. The CDN node 152, selected as the optimal node (hereinafter, also referred to as the optimal node 152), receives the content request signal from the CDN gateway 151, and transmits the content corresponding to the content request signal to the user terminal 110 instead of the origin server 160, so that the large capacity content may be provided to the user terminal 110 via an optimal path.

Here, when the corresponding content is present within a local cache of the selected optimal node 152, the optimal node 152 transmits the corresponding content cached to the local cache to the user terminal 110. Conversely, when the corresponding content is absent in the local cache of the optimal node 152, the optimal node 152 requests the origin server 160 or the other CDN nodes 152_1 to 152_4 for the corresponding content, receives the corresponding content from the origin server 160 or the other CDN nodes 152_1 to 152_4, and transmits the corresponding content to the user terminal 110.

Hereinafter, a content providing method according to the present invention will be described. The content providing method according to the present invention is a method performed by a content providing system according to the present invention and a function performed thereby is substantially identical.

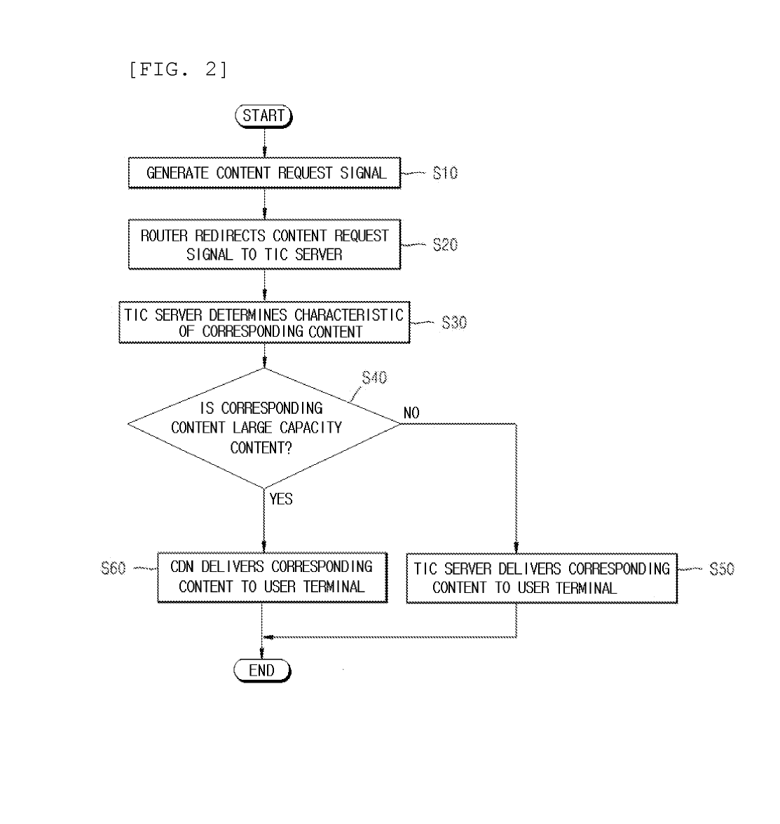

FIG. 2 is a flowchart illustrating a content providing method according to the present invention.

Initially, when a user requests desired content through a webpage or various types of applications, the user terminal 110 generates a content request signal that requests the content selected by the user (S10).

The content request signal is delivered to the router 120, and the router 120 redirects the content request signal to the TIC server 140 (S20).

The TIC server 140 receives a portion of corresponding content, obtains metadata of corresponding content, and determines a characteristic of corresponding content by referring to the obtained metadata (S30). As described above, the TIC server 140 may determine the characteristic of corresponding content by referring to a URL address of the origin server 160 that stores the corresponding content. For example, the TIC server 140 may determine whether the corresponding content is content being serviced using a streaming scheme in comparison with a URL address list of servers servicing the corresponding content using the streaming scheme.

When the corresponding content is small large capacity (S40), the TIC server 140 delivers the corresponding content to the user terminal 110 instead of the origin server 160 (S50).

Conversely, when the corresponding content is large capacity content corresponding to one of content serviced using the streaming scheme and content compressed in an image format of a high quality video (S40), the TIC server 140 redirects the content request signal to the CDN 150 so that the CDN 150 delivers the corresponding content to the user terminal 110 instead of the origin server 160 (S60).

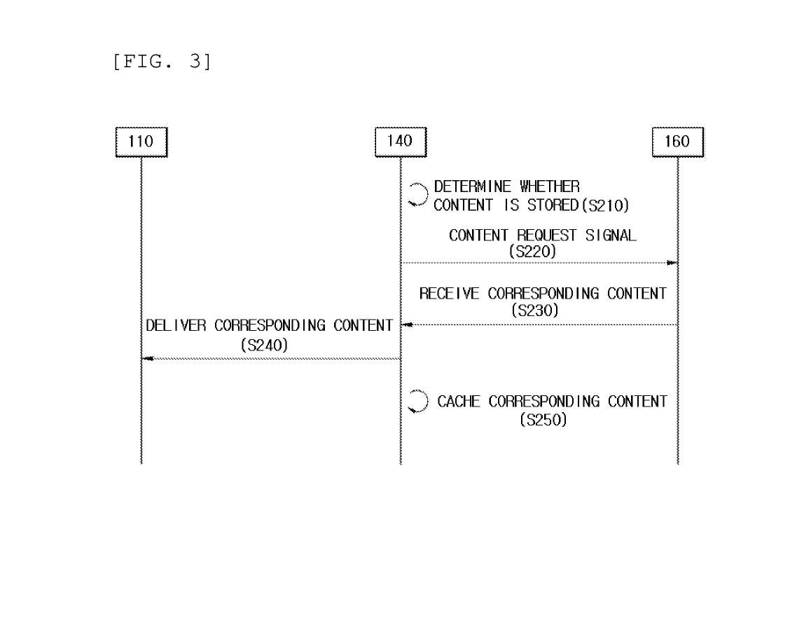

FIG. 3 is a flowchart to describe in detail operations S10 to S40 of FIG. 2.

As described above, the user terminal 110 generates a content request signal for requesting content selected by a user (S100).

The content request signal includes an URL address of the origin server 160 that is a destination storing the content, and in response to the content request signal, a transmission control protocol (TCP) session is connected between the user terminal 110 and the origin server 160 (S110).

The content request signal is delivered to the router 120 prior to being transmitted to the origin server 160 (S120), and the router 120 redirects the content request signal to the TIC server 140 (S130).

The TIC server 140 transmits the content request signal to the origin server 160 (S140), and receives a portion of corresponding content from the origin server 160, and obtains metadata of corresponding content (S150). The TIC server 140 may analyze the portion of corresponding content received from the origin server 160 and obtain metadata such as duration, a video/audio data rate, a frame rate, a file size, and the like.

The TIC server 140 determines a characteristic of corresponding content by referring to the obtained metadata (S160).

When the corresponding content is small capacity content, the TIC server 140 provides the corresponding content to the user terminal 110. When the corresponding content is large capacity content, the CDN 150 provides the corresponding content to the user terminal 110.

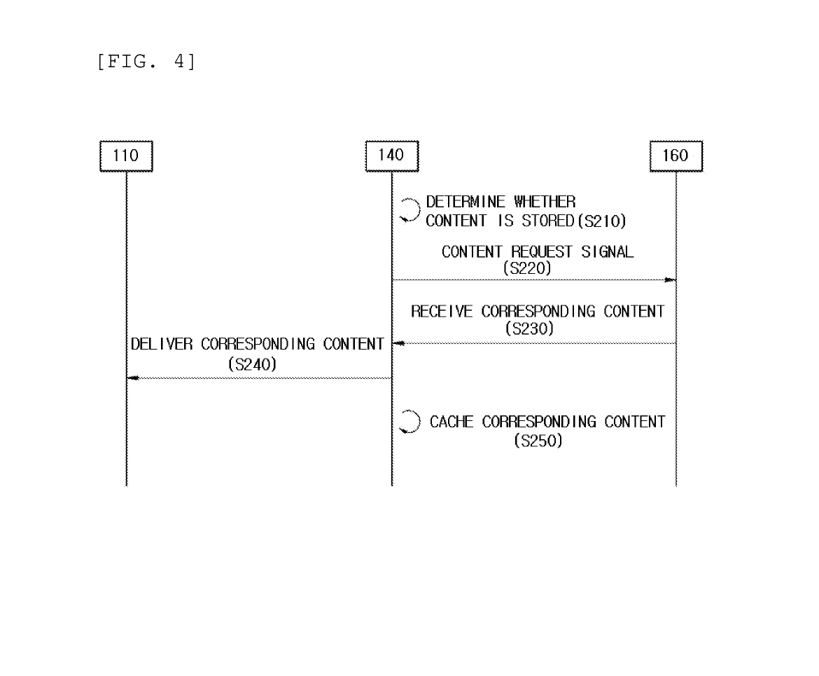

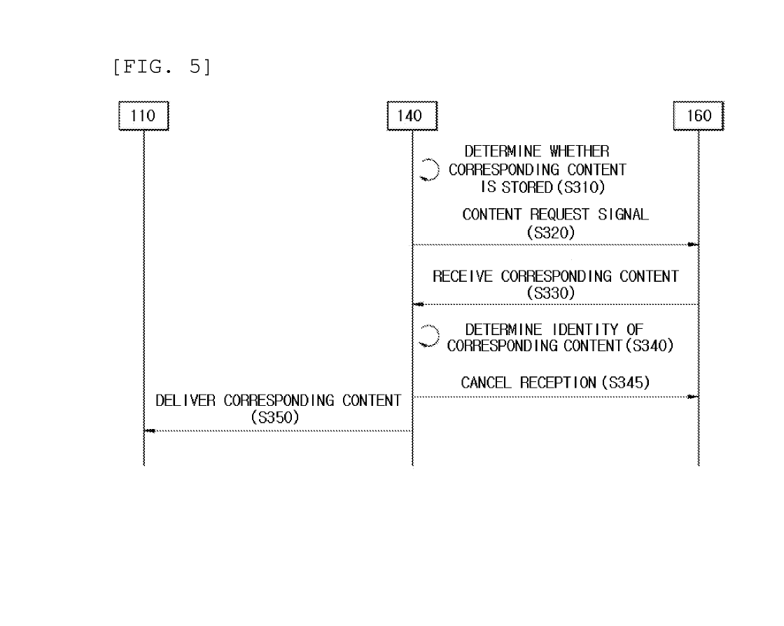

Hereinafter, an exemplary embodiment of the TIC server 140 will be described. Each of FIGS. 4 and 5 illustrates a process of delivering, by the TIC server 140, content corresponding to a content request signal to the user terminal 110.

FIG. 4 is a flowchart illustrating an operation process in a case in which corresponding content is not stored in a local cache within the TIC server 140.

Initially, the TIC server 140 determines whether corresponding content is stored in the local cache (S210).

When the corresponding content is not stored in the local cache, the TIC server 140 transmits a content request signal to the origin server 160 (S220) and receives the corresponding content from the origin server 160 (S230).

The TIC server 140 transmits the received corresponding content to the user terminal 110 (S240) and at the same time, caches the received corresponding content to the local cache (S250). Meanwhile, the TIC server 140 may be set to analyze a request amount of each content and cache only frequently requested corresponding content to the local cache, instead of caching all of contents to the local cache.

FIG. 5 is a flowchart illustrating an operation process in a case in which corresponding content is stored in a local cache within the TIC server 140.

Initially, the TIC server 140 determines whether corresponding content is stored in the local cache (S310).

Even when the corresponding content is stored in the local cache, the TIC server 140 transmits a content request signal to the origin server 160 (S320) and receives the corresponding content from the origin server 160 during a predetermined period of time or by a predetermined amount (S330).

Next, the TIC server 140 compares the received portion of corresponding content and the corresponding content stored in the local cache and determines identity of corresponding content (S340). Content stored in the origin server 160 may be modified and thus, be different from the content stored in the local cache of the TIC server 140. Accordingly, the TIC server 140 checks identity of corresponding content by comparing the received portion of corresponding content and the corresponding content stored in the local cache.

When the corresponding content present within the origin server 160 is identical to the corresponding content stored in the TIC server 140, the TIC server 140 cancels reception of content using a scheme of disconnecting a TIC session with the origin server 160 (S345).

Next, the TIC server 140 delivers, to the user terminal 110, the corresponding content stored in the local cache (S350).

Conversely, when the corresponding content present within the origin server 160 differs from the corresponding content stored in the TIC server 140, the TIC server 140 receives the corresponding content from the origin server 160, delivers the received corresponding content to the user terminal 110, and at the same time, caches the corresponding content to the local cache, which is similar to operations S230, S240, and S250 of FIG. 4, although not illustrated in FIG. 5.

In the present invention, although the TIC server 140 may directly provide content requested by the user terminal 110, the TIC server 140 transmits a content request signal to the origin server 160 and receives a portion of corresponding content at all times. The reasons follow as.

First, it is to verify whether content stored in the local cache of the TIC server 140 is latest. The TIC server 140 is unaware of whether the content stored in the local cache of the TIC server 140 is latest and thus, receives a portion of content of the origin server 160 and verifies whether cached content is latest content, based on the received portion of content.

Second, it is to protect paid content. In response to a request for providing content, the origin server 160 requests user information (ID/PW) with respect to the paid content and delivers the content only to a verified user. The TIC server 140 verifies that a user has a right to receive the content based on the fact that the corresponding content is received from the origin server 160.

Third, it is to provide a use performance of a user to a CP. On the side of the CP, when the CP is aware of which contents are frequently used by users, the CP may utilize the contents for marketing and advertisements. Accordingly, at all times, the TIC server 140 initially transmits a request of the user to the origin server 160, so that the CP may secure various types of statistical data (content popularity and taste for each user).

Hereinafter, an exemplary embodiment of the CDN 150 will be described. When content corresponding to a content request signal is large capacity content, the CDN 150 delivers the corresponding content to the user terminal 110 instead of the origin server 160.

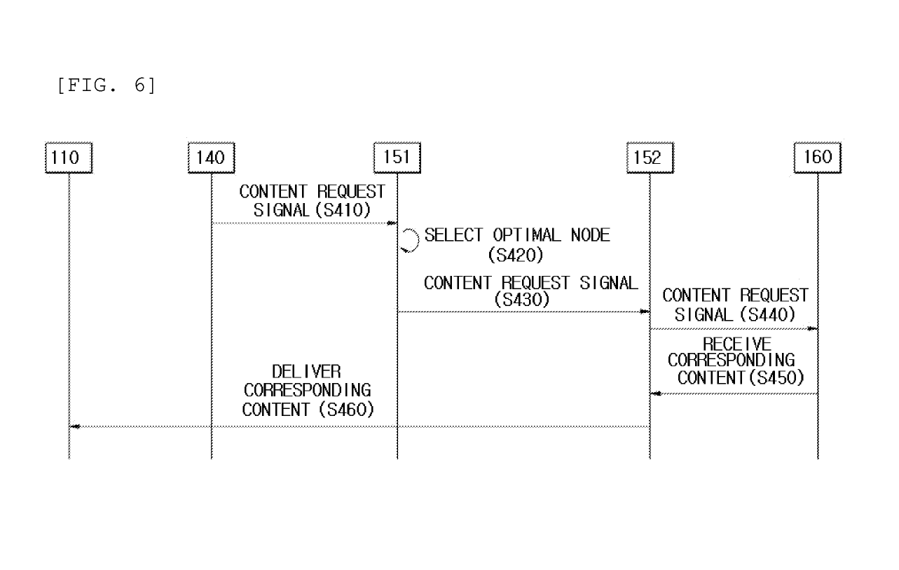

FIG. 6 is a flowchart illustrating a process of delivering, by the CDN 150, corresponding content to the user terminal 110.

In operation S160 of FIG. 3, the TIC server 140 determines a characteristic of corresponding content.

When the corresponding content is large capacity content, the TIC server 140 delivers a content request signal to the CDN gateway 151 (S410).

The CDN gateway 151 selects, as the optimal node 152, a node closest to the user terminal 110 or a node having the highest availability (S420).

The CDN gateway 151 delivers the content request signal to the selected optimal node 152 (S430).

The optimal node 152 transmits the delivered content request signal to the origin server 160 (S440), and receives corresponding content from the origin server 160 (S450).

The optimal node 152 delivers the received corresponding content to the user terminal 110 (S460).

Operations 5440 to 5460 of FIG. 6 may be configured as various exemplary embodiments based on whether the corresponding content is stored in local caches of the CDN nodes 152_1 to 152_n.

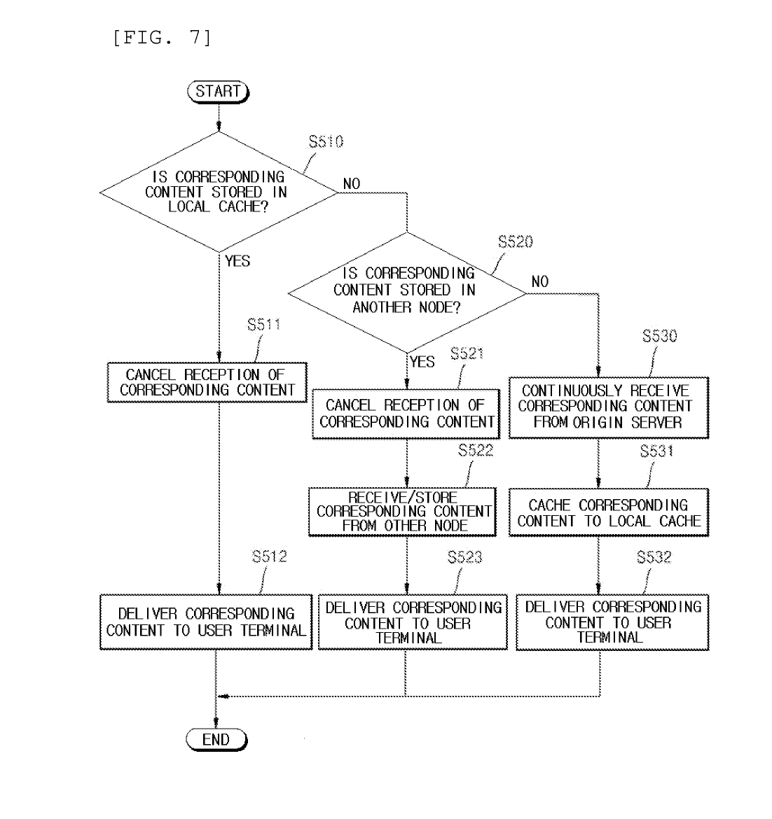

FIG. 7 is a flowchart to describe in detail a process of delivering, by the CDN 150, corresponding content to the user terminal 110.

Referring to FIG. 7, a content delivery scheme differs based on whether the corresponding content is present within the CDN 150.

Initially, the optimal node 152 determines whether the corresponding content is stored in the local cache (S510).

When the corresponding content is stored in a local cache of the optimal node 152, the optimal node 152 cancels reception of corresponding content from the origin server 160 (S511).

Next, the optimal node 152 transmits, to the user terminal 110, the corresponding content stored in the local cache of the optimal node 152 (S512).

When the corresponding content is not stored in the local cache of the optimal node 152 in operation S510 and stored in another CDN node in operation S520, the optimal node 152 cancels reception of corresponding content from the origin server 160 (S521).

The optimal node 152 receives the corresponding content from the other CDN node (S522) and transmits the received corresponding content to the user terminal 110 (S523).

Conversely, when the corresponding content is stored in none of the CDN nodes 152_1 to 152_n in operation S520, the optimal node 152 continuously receives the corresponding content from the origin server 160 (S530).

The optimal node 152 caches the received corresponding content to the local cache (S531) and at the same time, transmits the received corresponding content to the user terminal 110 (S532).

Although the CDN 150 may directly provide the corresponding content requested by the user terminal 110, the CDN 150 also transmits the content request signal to the origin server 160 and receives a portion of corresponding content at all times.

Similar to the reasons of the TIC server 140, the reasons are to verify whether content stored in the CDN 150 is latest, to protect paid content, and to provide a use performance of a user to a CP.

The method of the present invention may be implemented as a computer-readable code in computer-readable media. The computer-readable media includes all of the types of recording media storing data readable by a computer system. Examples of computer-readable media include ROM, RAM, CD-RO, magnetic tape, floppy disk, optical data storage device, and the like, and also include a form of carrier wave (for example, transmission over the Internet). The computer-readable media may be distributed over a computer system connected to a network and thereby store and execute a computer-readable code using a distributive scheme.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A content providing method performed by a content providing system comprising a content delivery network (CDN) and a transparent Internet cache (TIC) server configured to cache content and deliver the cached content to a user terminal, the method comprising:
(a) requesting, by the TIC server, an origin server for content corresponding to a content request signal received from the user terminal;
(b) receiving, by the TIC server, a portion of corresponding content from the origin server, and determining whether the corresponding content is large capacity content;
(c) caching, by the TIC server, the corresponding content, and providing the cached corresponding content to the user terminal when the corresponding content is determined as small capacity content; and
(d) caching, by the CDN, the corresponding content, and providing the cached corresponding content to the user terminal when the corresponding content is determined as the large capacity content.

2. The method of claim 1, further comprising:
redirecting, by a router, the content request signal received from the user terminal to the TIC server.

3. The method of claim 1, wherein the TIC server and the CDN receive a portion of corresponding content from the origin server even in the case of caching the corresponding content.

4. The method of claim 1, wherein the (c) comprises:
requesting, by the TIC server, the origin server for the corresponding content and receiving the corresponding content from the origin server;
cancelling, by the TIC server, reception of corresponding content in the case of caching the corresponding content; and
transmitting, by the TIC server, the caching corresponding content to the user terminal.

5. The method of claim 1, wherein the (c) comprises:
requesting, by the TIC server, the origin server for the corresponding content and receiving the corresponding content from the origin server; and
receiving, by the TIC server, all of corresponding content from the origin server and delivering the corresponding content to a user in the case of not caching the corresponding content.

6. The method of claim 5, further comprising:
caching, by the TIC server, the corresponding content received from the origin server to a local cache in the case of not caching the corresponding content.

7. The method of claim 1, wherein the (d) comprises:
(d1) delivering, by the TIC server, the content request signal to a CDN gateway of the CDN;
(d2) selecting, by the CDN gateway as an optimal node, a CDN node closest to the user terminal or having the highest availability among CDN nodes; and
(d3) providing, by the selected optimal node, the corresponding content to the user terminal.

8. The method of claim 7, wherein the (d3) comprises:
requesting, by the selected optimal node, the origin server for the corresponding content and receiving the corresponding content from the origin server;
cancelling, by the selected optimal node, reception of corresponding content in the case of caching the corresponding content; and
transmitting, by the selected optimal node, the caching corresponding content to the user terminal.

9. The method of claim 7, wherein the (d3) comprises:
requesting, by the selected optimal node, the origin server for the corresponding content and receiving the corresponding content from the origin server;
cancelling, by the selected optimal node, reception of corresponding content in a case in which a CDN node aside from the selected optimal node is caching the corresponding content; and
receiving, by the selected optimal node, all of corresponding content from the CDN node caching the corresponding content and delivering the corresponding content to the user terminal.

10. The method of claim 7, wherein the (d3) comprises:
requesting, by the selected optimal node, the origin server for the corresponding content and receiving the corresponding content from the origin server; and
receiving, by the selected optimal node, all of corresponding content and delivering the corresponding content to the user terminal in a case in which the selected optimal node and another CDN node are not caching the corresponding content.

11. A content providing system comprising a CDN and a TIC server configured to cache content and deliver the cached content to a user terminal, the system comprising:
a router configured to intercept a content request signal and to redirect the content request signal to the TIC server;
an origin server configured to store originals of various contents;
the TIC server configured to cache small capacity content from the origin server and to provide the cached small capacity content to the user terminal; and
the CDN configured to cache large capacity content from the origin server and to provide the cached large capacity content to the user terminal,
wherein the TIC server requests the origin server for content corresponding to the content request signal, receives a portion of corresponding content from the origin server, determines whether the corresponding content is large capacity content, and determines a providing entity of corresponding content based on whether the corresponding content is large capacity content.

12. The system of claim 11, wherein the TIC server requests the origin server for the corresponding content and receives the corresponding content from the origin server, and in the case of caching the corresponding content, cancels reception of corresponding content and then transmits the caching corresponding content to the user terminal.

13. The system of claim 11, wherein the TIC server requests the origin server for the corresponding content and receives the corresponding content from the origin server, and in the case of not caching the corresponding content, receives all of corresponding content from the origin server and delivers the received corresponding content to the user.

14. The system of claim 13, wherein in the case of not caching the corresponding content, the TIC server caches the corresponding content received from the origin server to a local cache.

15. The system of claim 11, wherein
the TIC server delivers the content request signal to a CDN gateway of the CDN,
the CDN gate way selects, as an optimal node, a CDN node closest to the user terminal or having the highest availability among CDN nodes, and
the selected optimal node provides the corresponding content to the user terminal.

16. The system of claim 15, wherein the selected optimal node requests the origin server for the corresponding content and receives the corresponding content from the origin server, and in the case of caching the corresponding content, cancels reception of corresponding content and then transmits the caching corresponding content to the user terminal.

17. The system of claim 15, wherein the selected optimal node requests the origin server for the corresponding content and receives the corresponding content from the origin server, and in a case in which a CDN node aside from the selected optimal node is caching the corresponding content, cancels reception of corresponding content, receives all of corresponding content from the CDN node that is caching the corresponding content, and transmits the received corresponding content to the user terminal.

18. The system of claim 15, wherein the selected optimal node requests the origin server for the corresponding content and receives the corresponding content from the origin server, and in a case in which the selected optimal node and another CDN node are not caching the corresponding content, receives all of corresponding content and transmits the received corresponding content to the user terminal.
